(19) United States
(12) Patent Application Publication
(10) Pub. No.: US 2007/0237369 A1
(43) Pub. Date: Oct. 11, 2007

(54) Method for displaying a number of images as well as an imaging system for executing the method

(76) Inventors: Thomas Brunner, Nurnberg (DE); Frank Deinzer, Rothenbach (DE); Benno Heigl, Coburg (DE); Jochen Michel, Koblenz (DE); Norbert Rahn, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/496,068

(22) Filed: Jul. 28, 2006

(30) Foreign Application Priority Data
Jul. 28, 2005 (DE) 10 2005 035 929.9

(51) Int. Cl. G06K 9/00

(52) U.S. Cl. 382/128

(57) ABSTRACT

The invention relates to a method for presenting a number of two- or three-dimensional images from different modalities registered with each other, with points of interest being able to be assigned to an individual image of the modalities and in all images selectable graphics primitives being overlaid on the assigned points of interest so that a visual assignment of points of interest or area of interest between simultaneously displayed two- or three-dimensional images occurs, as well as an imaging system of a workstation for executing the method.

### CROSS REFERENCE TO RELATED APPLICATIONS

This application claims priority of German application No. 10 2005 035 929.9 filed Jul. 28, 2005, which is incorporated by reference herein in its entirety.

### FIELD OF THE INVENTION

The invention relates to a method for displaying a number of two- and/or three-dimensional images registered with each other from different modalities as well as an imaging system of a workstation for executing the method. These types of methods or devices are used in medical engineering for simultaneous presentation of a number of images of different modalities on one monitor or on a number of monitors.

### BACKGROUND OF THE INVENTION

3D reconstructions of volume data from image data of angiography, CT and MR systems are becoming ever more important in many diagnostic and interventional fields. In particular these reconstructions are very helpful in treating tumors, aneurysms and stenoses.

In medical diagnostics the aim is to make it such diseased changes visible. Depending on the type of illness and the imaging modality, contrast means can improve visibility or simply even make it possible.

For an interventional treatment of these diseased changes, the points in the body affected are reached during the radioscopy of a 2D projection via catheters or needles so that treatment can be undertaken directly at the location of the disease. The problem in this case is that tissue or tumors for example are not visible without injection of contrast means during radioscopy. This makes precise localization of the affected point in the body difficult.

For anatomical orientation during treatment, for example to guide a needle, there are currently a number of options available:
Using anatomical knowledge alone and treatment using radioscopy,
Making individual vessels, which then function as orientation points, visible by employing contrast means, for example by means of digital subtraction angiography (DSA),
Repeated Injection of contrast means, creation of a radiographic image and storing this instantaneous image in further images (DSA)—but this must however be repeated for each change of the angulation of the C-arm or other changes such as zoom, SID (Source Image Distance) or table position,
Repeated execution of 3D reconstructions at short intervals, with the relevant locality of the needle being able to be established, or
Artificial projections of volume data in which the affected areas are visible, can be created and underlaid onto the radioscopy image, as is described for example in DE 102 10 646 A1.

In addition there are already a few methods which are defined by the term “Linked Cursor” or maintained as a product in the Literature of Service Hospitalier Frédéric Joliot (SHFJ), CEA/DSV: at http://www-dsv.cea.fr/Topic/shfj/web/demo_recalage/english/curseur.htm [1]. The Syngo 3D application should be mentioned especially at this point. In this system two different 3D-volume data sets, which have been produced for example by different modalities, can be registered. This can for example be found in the product help for “3D Fusion (overview)”.

In MPR displays a change in the position of the mouse cursor leads to a corresponding change in the virtually displayed cursor in the second MPR view. This is restricted however to MPR displays. At the above link a method is presented which also processes registered MR and SPECT data. This involves a linked cursor variant which has been designed exclusively for 3D data.

“Linked Cursor” refers to a linked marking in which the two images are shown in separate (pop-up-) windows, if possible even on separate screens, with the two windows having a linked cursor.

The “linked cursor” is here the intersection point of the straight lines in the individual images. There is no description, but “linked cursor” on the basis of a fixed definition for it, is that one and the same 3D point is identified in different views or volumes either with a mouse cursor or with a cross-hair, as on the cited Web page.

A definition for “linked cursor” can be found in the document “http://www-ipg.umds.ac.uk/J.Blackall/05_background.pdf” from the PhD Thesis of Jane M. Blackall “Respiratory Motion in Image-Guided Intervention of the Liver”, pages 17 to 27: “A linked cursor is provided so that corresponding features of interest in the two images can be identified more easily.”—A linked cursor is provided so that corresponding features of interest can be more easily identified in the two images.

This is exactly what can be seen in the images of [1], a unique correspondence between an MR data set, given by three sectional planes (MPRs), and a SPECT data set also produced by three sectional planes. The cross-hairs identify the same anatomical location in both data sets.

An MPR display is a post-processing of the 3D volume data, the multiplanar reconstruction. With multiplanar reconstruction new sectional images in any orientation can be reconstructed on the basis of a 3D or a contiguous multilayer measurement.

### SUMMARY OF THE INVENTION

The underlying object of the invention is to embody a method and an imaging system of the type mentioned at the start which makes it possible for the person conducting the examination to obtain a simple and intuitive display of important points within an image.

The object is achieved in accordance with invention by points of interest—POIs being able to be assigned to an individual image of the modalities and that in all images the assigned points of interest are overlaid with identifying selectable graphics primitives so that a visual assignment of points of interest or areas of interest is undertaken between simultaneously displayed two and/or three-dimensional images. This produces a graphical process for resolving the correspondence problem between volume data sets and for example a radioscopy image.

A simple detection and improved overview with a number of points of interest is obtained when freely-selectable textual descriptions can be assigned to these points.

Advantageously the three-dimensional images can be displayed from a 3D volume data set on a workstation.

A especially simple selection of points of interest is produced if these can be selected in a freely-selectable sectional plane of MPR displays.

It has proved an advantage for points of interests not visible in an image to be shown in a different way on one of the other images so that the doctor sees immediately which points of interest are missing from the currently selected image area of the system.

In accordance with the invention the selected points of interest can be displayed on the current radioscopy image of the examination monitor of a C-arm system.

In an advantageous manner the 3D graphics primitives can be selected from the group sphere, cube and solid rectangle and the 2D graphics primitives from the group circle, square, rectangle, cross.

It has proved advantageous if the textual description next to the selected points of interest can be stored in the form of a list and displays further functions which for example can make it possible to “delete”, “hide” and or “go to point”.

The object is achieved for an imaging system of a workstation in accordance with the invention by the imaging system featuring a device for controlled selection of points of interest in one of the images stored in a data memory linked to each other, by the locations of the points of interest being stored in a memory, by a graphics generator generating graphics primitives which are overlaid in all images by means of a device.

In accordance with the invention the data memory can be embodied for storage of a 3D volume data set.

It has proved to be advantageous for the memory to be embodied for storage of a freely-selectable textual description assigned to the relevant points of interest or embodied for storage of features assigned to the relevant points of interest.

It is also possible to select points of interest within a volume in a simple manner if the imaging system features a device for setting the transfer function.

The operation is simplified and the accuracy of the selection of the points of interest is increased if the imaging system features a device for automatic point determination.

### BRIEF DESCRIPTION OF THE DRAWINGS

The invention is explained below in greater detail on the basis of the exemplary embodiments shown in the drawing. The figures show:

FIG. 1 a hospital network,

FIG. 2 an inventive imaging system of a workstation in accordance with FIG. 1,

FIG. 3 a point selection in the volume display,

FIG. 4 a selection of points of interest on the 3D vessel tree,

FIG. 5 a selection of a point in an MPR view,

FIG. 6 a volume display with parts of the volume hidden with specific densities as a result of a selectable transfer function,

FIG. 7 a real time display of the selected points on the examination monitor of a C-arm system,

FIG. 8 a real time display of the selected points on the examination monitor of the C-arm system with angulation changed in relation to FIG. 7, and

FIG. 9 a list of the selected points.

### DETAILED DESCRIPTION OF THE INVENTION

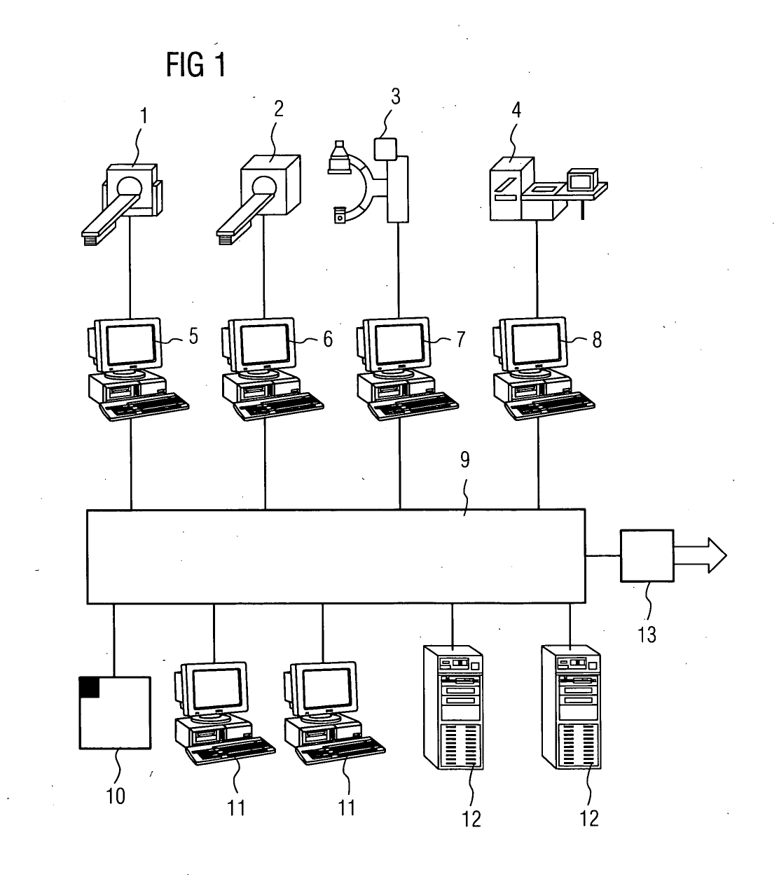

FIG. 1 shows an example of the system architecture of a hospital network. Modalities 1 to 4 are used to record medical images, which as image generating systems, can for example feature a CT unit 1 for computer tomography, an MR unit 2 for magnetic resonance, a C-arm system 3 and an x-ray unit 4 for digital radiography. Connected to these modalities 1 to 4 are operator consoles of the modalities or workstations 5 to 8, with which the recorded a medical images can be processed and stored locally. Patient data pertaining to the images can also be entered.

Workstations 5 to 8 are connected to a communication network 9 as a LAN/WAN backbone for distribution of the created images and communication. Thus for example the images created in the modalities 1 to 4 and further processed in the workstations 5 to 8 can be stored in central image storage and image archiving systems 10 or forwarded to other workstations.

Further viewing workstations 11 are connected to a communication network 9 as results consoles which feature local image memories. Such a viewing workstation 11 is for example a very fast, small computer based on one or more fast processors. In the viewing workstations 11 the images recorded and stored in the image archiving system 10 can be subsequently called up for investigation and stored in the local image memory from which they can be made directly available to a researcher working at the workstation 11.

Furthermore patient data servers (PDS) file servers, program servers and/or EPR servers can be connected to the communication network 9 server 12.

Images and data are exchanged over a communication network 9 in such cases in accordance with the DICOM, an industry standard for transfer of images and further medical information between computers, so that a digital communication between the diagnosis and therapy devices of different manufacturers is possible. A network interface 13 can be connected to the communication network 9 via which the internal communication network 9 is connected to a global data network, for example the World Wide Web, so that the standardized data can be exchanged worldwide with different networks.

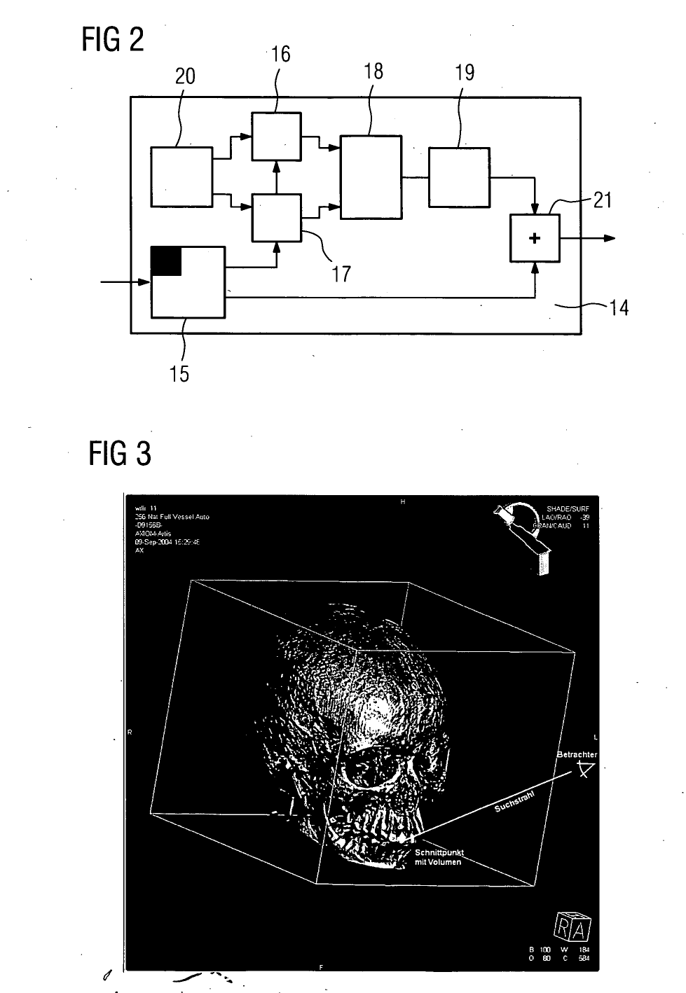

An imaging system 14 of one of the workstations 5 to 8 and 11 is shown as an example in FIG. 2. In addition to other generally known components it features a data memory 15 in which the volume data sets of the CT unit 1, the MR unit 2 and/or the C-arm system 3 can be stored This volume data set can however also have been loaded via the communication network from the central image memory and the image archiving system 10 into the data memory 15.

Furthermore the imaging system 14 features a device 16 for selecting points of interest. By means of this device 16 the points in the images on the monitors not shown in this figure connected to the imaging system 14 can be selected. Furthermore a device 17 for point determination can be provided, which in addition to the selection of the points of interest executes an automatic determination of the points for example according to the ray trace method which will be described below.

A memory 18 is connected to these devices 16 and 17 in which these selected points of interest are stored with a sequence number, a modifiable textual description and the associated 3D co-ordinates. On the basis of the stored settings a graphics generator 19 causes 2D or 3D graphics primitives to be generated which are incorporated into the image in a mixing stage 21 connected to a monitor of the workstation 5 to 8 or 11.

FIG. 3 shows a point selection in the volume display. A search ray is sent from the position of the observer, selected by clicking with the mouse in the window, into the volume. The first intersection point with a visible voxel is selected as 3D-POI.

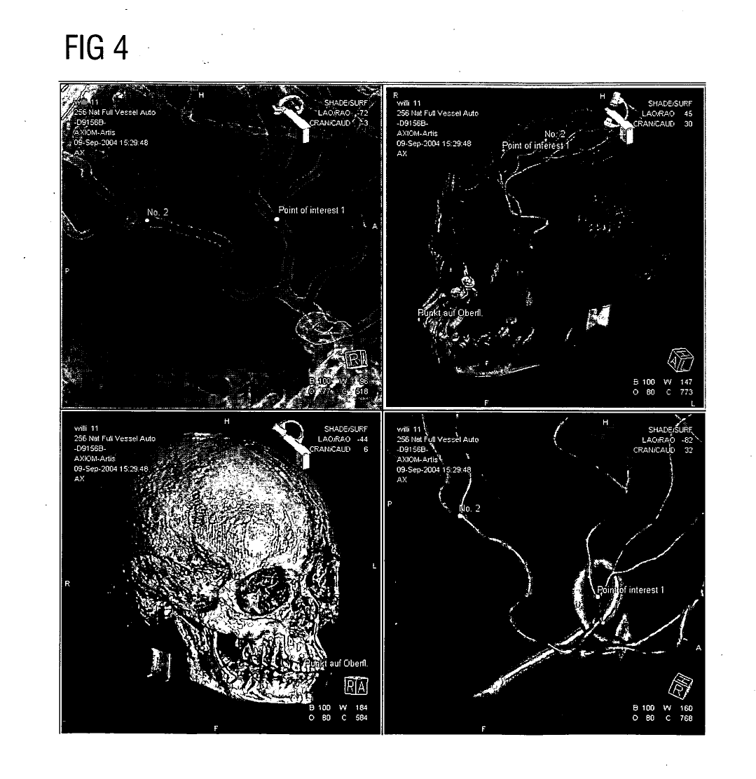

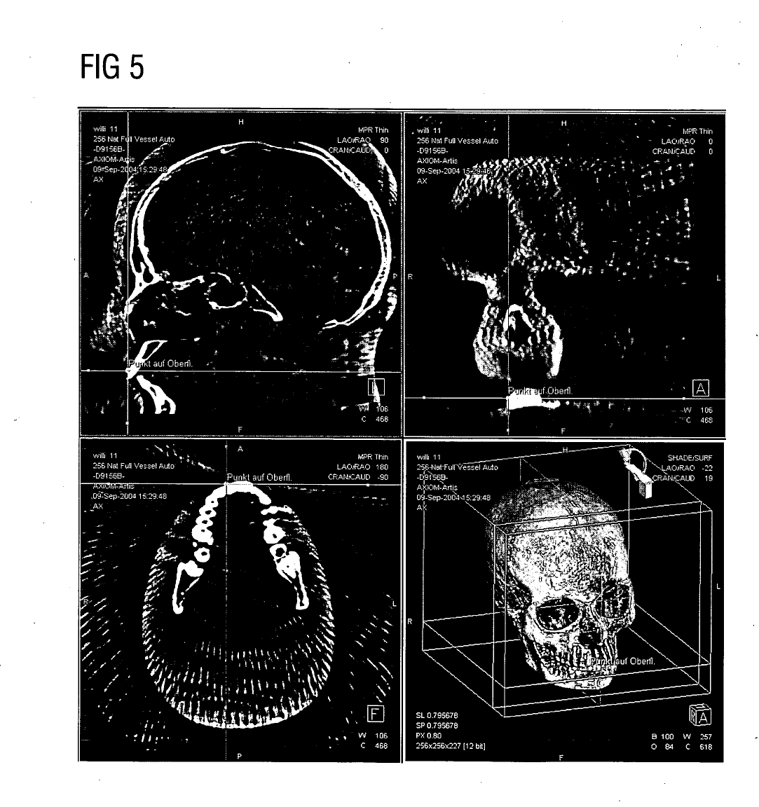

The selection of points of interest in a 3D vessel tree is explained with reference to FIG. 4 upper left and lower right. The transfer function has been set on the device 20 so that a point selection within the volume is possible. To the bottom left the selection of a point of interest on the surface of the skull is shown. Here the transfer function is set so that the skull bone components are visible and thereby a point selection on its surface is possible. In the window at the top right the transfer function and perspective have been set so that all selected points can be seen at once.

In FIG. 5 a point of interest in one of the MPR views has been selected. Subsequently the “go to” function described with reference to FIG. 9 has been employed to display the plane in all MPR views in which the point of interest lies. The volume presentation to the bottom right also shows the point of interest The selected MPR planes are also indicated there. The MPR displays to the top left, top right, bottom left are the “classical” cross-sectional displays of 3D data sets. This means that they are a layer cut out of the volume with a defined thickness (e.g. 1 mm).

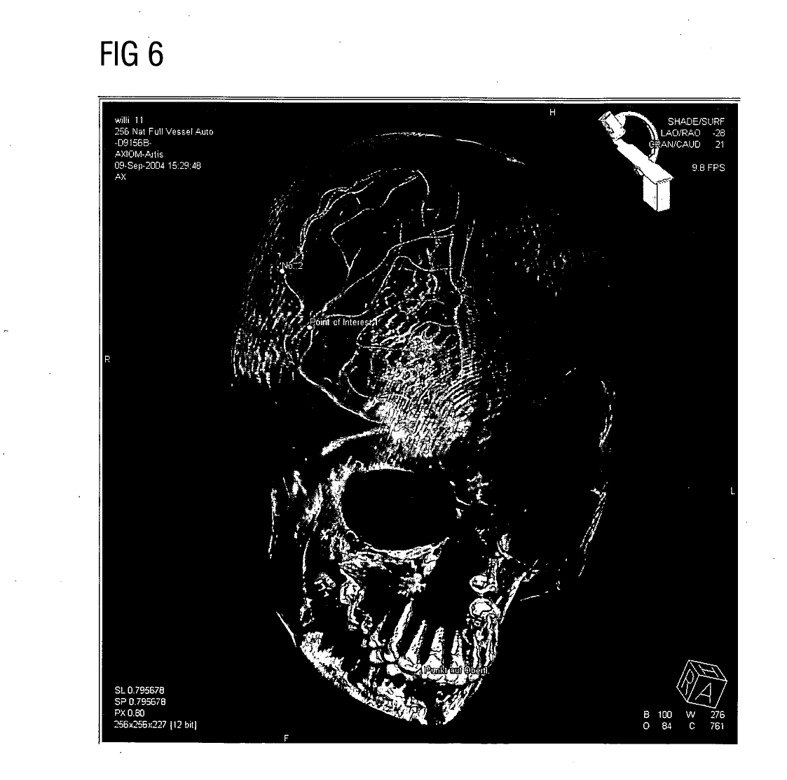

All selected points of interest are normally always displayed, but can if desired be temporarily hidden or deleted altogether. In FIG. 6 it can also be seen that, depending on the setting of the transfer function, volume sections with a specific thickness can be hidden and thereby all POIs made visible. The volume can then be freely rotated in space in order to select or to display new POIs. How the points of interest are temporarily hidden or deleted will be explained below with reference to FIG. 9.

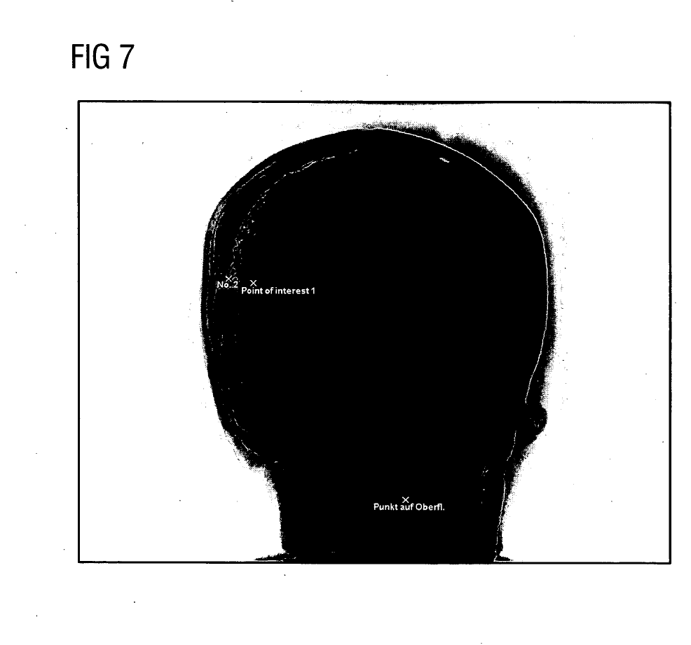

FIG. 7 shows a real time display of the selected points of interest on the examination monitor of the C-arm system 3. The points of interest selected beforehand in the 3D or MPR display match the radioscopy image. A change in the system parameters such as an angulation etc for example directly changes the position of the markings of the points of interest in the form of crosses and of the text—the points of interest would lie at the indicated positions if another image was taken.

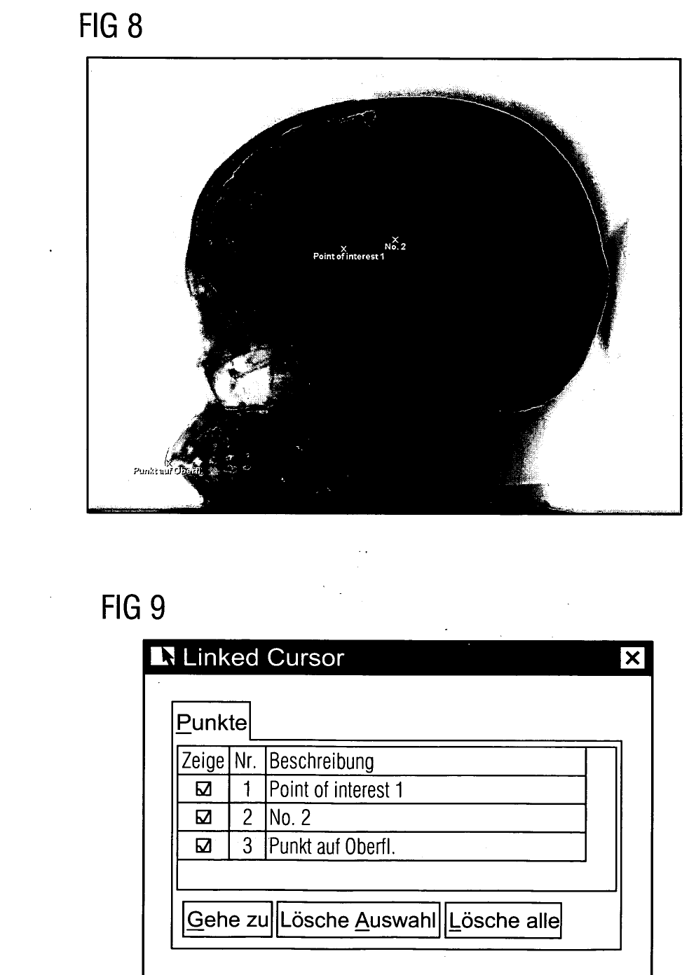

FIG. 8 shows a real time display of the selected points of interest on the examination monitor of the C-arm system 3, in which the angulation of the C-arm has been changed. The marked points of interest have moved as well in this case. The result after a further image is recorded can be seen here. It can be seen that the crosses correspond to the previously selected 3D points.

FIG. 9 shows a pop-up list of the selected points for the “linked-cursor”. Each point contains a sequence number and a text description. By clicking on the corresponding check box in the “show” column, a point can be temporarily hidden or shown. Clicking on the “go to” button shows the point selected by the marked row in all MPR images. The two “delete” buttons allow either the selected point or all points to be deleted.

Since a doctor performing the treatment is often not interested in a realistic overlaid presentation of a number of examination images—instead he wishes to have his current radioscopy image enriched with simple additional information as an aid to orientation. For this purpose the overlay presentation of suitable graphics primitives is especially suitable.

The present method makes this possible in that
1. Points of interest—POIs are selected in the 3D volume data set on a workstation and can be provided with a freely-selectable textual description, as can be seen from the figures,
2. The selected points in the volume and MPR can be represented by suitable graphics primitives and
3. In addition the selected points can be displayed on the current radioscopy image of the examination monitor of the C-arm system.

This also makes the visual assignment of points of interest or areas of interest between a 3D volume display and the 2D radioscopy image on the examination monitor possible.

As an alternative, points of interest can also be selected in the freely-selectable planes of the MPR representation and also be provided with a freely-selectable textual description, as is shown in FIG. 5.

The points of interest are stored in a list and displayed, which makes possible further functions such as delete, hide or “go to” (point), as is explained with reference to FIG. 9.

The selection of points of interest in the volume display (see point 1) can be effected intuitively using the relevant transfer function selected. The effect of the transfer function is that only parts of the volume (voxel) are displayed for which the density meets specific criteria

This enables the only bones or only vessels with contrast means to be easily displayed. With the aid of the freely-selectable transfer function using device 20 the volume data set is also interactively segmented.

The actual point selection can be undertaken in a simple manner:
In a similar way to a ray tracer a search ray is sent from the 2D screen position clicked on into the volume. In this case under normal circumstances the ray traverses numerous voxels depending on the transfer function set. If a displayed voxel is now found (depending on the transfer function) the 3D co-ordinates of this voxel are selected: The selection is also made along the line of sight “the first voxel that one sees”.
In the MPR displays a point selection is at least just as simple and intuitive. In the MPR mode three sectional planes with different orientation are displayed. These can however also be freely modified as regards their position and alignment in order to display to the doctor carrying out the treatment the location of the illness in the sectional planes that he requires.
A point of interest can be displayed in the MPR presentations by simply clicking with the mouse on the desired point, since the point already represents a unique 3D point on an MPR sectional plane.

A point of interest is included independently of the type of selection in a list which is administered by a sequence number, a modifiable textual description and the 3D-co-ordinates, as is described with reference to FIG. 9.

In addition to the selection there is a further function in MPR mode which allows a “jump” to be made to a POI previously selected from a list. This means that the plane in which the POI lies is selected in all MPR views The selected point can thus be seen simultaneously in all views from different perspectives (cf. FIGS. 5 and 9).

The selected points of interest can be highlighted in the 3D volume presentation for example by a sphere, a cube, a rectangular solid or similar 3D graphic primitive and the textual description alongside it. In the two-dimensional MPR presentations the 2D graphics primitives involved can be a circle, a square, a rectangle, a cross or similar with the text alongside them (see FIG. 5). Furthermore the selected points in both types of presentation can also be connected by lines or parameterized curves if required.

A suitable 2D-3D registration enables the POIs to be simultaneously displayed on the examination monitor of the C-arm system 3 with the radioscopy image. A 3D-2D mapping of the co-ordinates of the selected 3D points to 2D screen co-ordinates of the examination monitor he is thus performed The registration makes it possible to assign any given 3D point uniquely to a 2D point.

The 2D-3D registration can be undertaken in the known manner by suitable calibration of the system, image-based or landmark-based registration methods.

The presentation of the two key points on the examination monitor can for example be performed using crosses, circles, squares, rectangles or similar 2D graphics primitives which overlay the current radioscopy image, as can be seen from FIGS. 7 and 8. The position of the graphics primitives and the textual description also shown here is computed from the 3D-2D mapping of the respective POIs. Here too the individual graphics primitives can be connected by lines or parameterizable curves.

In any event a change of the angulation of the C-arm or a change to other parameters of the C-arm system, for example table position, zoom SID etc., has a direct effect on the displayed graphics primitives. As soon as the patient moves or the angulation of the C-arm or of the other system parameters changes, the displayed points are no longer valid. The radioscopy image presented also no longer corresponds to the changed system settings. In this case they are deleted from the screen, the positions are computed once again with the aid of the known 2D-3D registration and subsequently displayed at the computed positions. The doctor can follow on the examination monitor the location at which the selected points (and thereby his area of interest or the location of the disease) would “migrate” if an image were to be recorded with the current system setting (cf. FIG. 8). Thus it can be established for example whether a needle has really reached a particular point. This is often difficult to assess with a single radioscopy image without being able to compare it with images recorded at other angulations.

If for example the zoom factor or the table position of the C-arm system was changed it can be at that specific points of interest are no longer visible on the examination monitor since they lie outside the area presented. In this case the corresponding points are identified in the MPR and 3D volume display, e.g. by a different color or another graphics primitive.

The inventive features described previously are implemented in real time while the doctor performing the treatment is operating the system.

The problem of correspondence between 3D volume display and 2D radioscopy image can be resolved physically by the doctor using the inventive graphical method. In use the doctor can mark the location of the disease by setting points of interest. For this purpose he can refer back to both the volume and also the MPR display of the workstation. The selected points are immediately displayed at the corresponding positions on the examination monitor of the C-arm system and overlaid with the radioscopy image. Each point can also be described with a text. This makes it easier to distinguish between the points of interest, especially in the x-ray image. Overall the method helps to establish an intuitive relationship between a volume reconstruction, MPR planar display and radioscopy image on the examination monitor. Anatomical navigation is simplified and dealing with the C-arm system thus becomes more intuitive.

The doctor can, even before any new radioscopy imaging may be required, set the geometry of the system to its optimum in order to record an image of the area of interest to him. On the examination monitor he can follow where his selected points of interest will lie for current system parameters. This is done automatically, in real time and—once the points of interest are selected—without additional interaction effort.

In the radioscopy image points of interest may not be visible if for example the system has zoomed into an area or the table position has changed. However these points continue to be visible in the 3D volume. The corresponding points are shown in different ways in the MPR and 3D volume display so that the doctor sees immediately which points of interest are missing from the currently selected image area of the system. This thus contributes to a simplified anatomical navigation and intuitive operation of the system.

Under some circumstances the system enables additional radiographic images or a new enhancement using contrast means to be dispensed with After a 3D reconstruction of the location of the disease to be treated has been undertaken all information is available to find any locations in the radioscopy image which are present in the 3D reconstruction and are of interest (e.g. puncture points). Contours of organs or vessels can also be displayed by selecting a number of POIs along the organ or vessel boundary.

1-16. (canceled)

17. A method for simultaneously displaying a plurality of medical images from a plurality of modalities, comprising:
assigning a point of interest to one of the images from one of the modalities; and
overlaying the point of interest in all the images from the modalities with an identifying graphic shape so that the point of interest is visualized between simultaneously displayed images from the modalities.

18. The method as claimed in claim 17, wherein the medical images are three-dimensional or two-dimensional.

19. The method as claimed in claim 18, wherein the three-dimensional images are displayed on a workstation from a three-dimensional volume data set.

20. The method as claimed in claim 17, wherein the point of interest is selected in a sectional plane of a multiplanar reconstruction display.

21. The method as claimed in claim 17, wherein the point of interest which is not visible in one image is shown differently in the other images.

22. The method as claimed in claim 17, wherein the point of interest is overlaid and displayed on a radioscopy image of an examination monitor of a C-arm system.

23. The method as claimed in claim 17, wherein the identifying graphic shape is three-dimensional or two-dimensional.

24. The method as claimed in claim 23, wherein the three-dimensional graphic shape is selected from the group consisting of: sphere, cube, and rectangular solid.

25. The method as claimed in claim 23, wherein the two-dimensional graphic shape is selected from the group consisting of: circle, square, rectangle, and cross.

26. The method as claimed in claim 17, wherein the point of interest is assigned with a textual description.

27. The method as claimed in claim 26, wherein the point of interest as well as the assigned textual description are stored and displayed in a list for a further function.

28. The method as claimed in claim 27, wherein the further function is deletion, hiding, or go to point.

29. An imaging system for simultaneously displaying a plurality of medical images from a plurality of modalities, comprising:
a first memory for storing image volume data sets of the images;
a selecting device for selecting a point of interest in one of the images from one of the modalities;
a second memory for storing a location of the point of interest;
a graphics generator for creating a graphic shape for the point of interest; and
a calculating device for overlaying the point of interest in all the images from the modalities with the graphic shape so that the point of interest is visualized between simultaneously displayed images from the modalities.

30. The method as claimed in claim 29, wherein the medical images are three-dimensional or two-dimensional.

31. The imaging system as claimed in claim 29, wherein the second memory stores a textual description assigned to the point of interest.

32. The imaging system as claimed in claim 29, wherein the second memory stores a feature assigned to the point of interest.

33. The imaging system as claimed in claim 29, wherein the imaging system comprises a device for setting a transfer function.

34. The imaging system as claimed in claim 33, wherein the transfer function sets the point of interest been seen within different displays of the one of the images.

35. The imaging system as claimed in claim 29, wherein the imaging system comprises a device for automatically determining the point of interest.
